(19) United States
(12) Patent Application Publication
(10) Pub. No.: US 2011/0282633 A1
(43) Pub. Date: Nov. 17, 2011

(54) Component building system

(76) Inventor: Thuan Bui, Philadelphia, PA (US)

(21) Appl. No.: 12/800,215

(22) Filed: May 11, 2010

(51) Int. Cl. G06F 17/50; E04B 2/86; E04B 1/62; E04B 2/56

(52) U.S. Cl. 703/1; 52/783.1; 52/781.5; 52/506.05

(57) ABSTRACT

A component building system that is cost effective and flexible enough to be adapted for single story to multi-stories building structures. The component system comprises of mostly standardized open rib wall panel components and floor panel components. The basic open rib wall panel component's design is comprised of a cementitious sheathing with a narrower back supporting frame attached to it to create cavities on the side of panel for concrete to form studs when the panels are assembled and concrete is pour in cavities.

### FIELD OF THE INVENTION

The present invention relates to a component building system with standardized panel components and customizable components, having 3D modeling software that can automate and facilitate the component assembling process.

### BACKGROUND OF THE INVENTION

Building structures are often built on site in many parts of the world. The problems of site construction are well documented in past journal articles. The major problems of site building method are high skilled labor cost, inconsistent labor cost in almost every stage of construction, higher material waste, and poor and inconsistent quality.

In attempts at solving these problems, many people have tried to come up with many types of modular wall panels and components that can be pre-engineered and mass-produced to reduce cost and to be speedily assembled into walls at building site. Unfortunately, previous attempts have failed and have made little or no impact in the building industry. The reasons for past failures are high material cost of modular panels, cost of manufacturing the modular panels, the complexity of system or difficulty of implementation, and lack of flexibility of the system to enable it to build multiple stories economically.

There has been a need for a viable modular building system that is simple to assemble, simple to manufacture, involves less material cost, is flexible enough to allow customizable elements in the building structure, and will reduce both engineering, designing, and general contracting redundancies in the building process. This patent application represents such a building system.

### SUMMARY OF THE INVENTION

This invention is of a component wall system that is cost effective and flexible enough to allow customization in building structures. All the system's wall panels are of open rib or frame panel design with the sides shaped or designed to allow formation of pour-in-place concrete studs and headers that will join all panels together into a monolith structure. The main wall panel components are standardized panels of various standard width and height with or without openings. The standardized wall panels form the basic building blocks of this system. The building system can accommodate other standard size floor products such as hollow core concrete panels, but the preferred floor panel is made of steel supporting frame attached to a thin layer of concrete. This preferred floor panel would cost less in both material cost and transportation as it would be at least ⅓ the weight and use less materials. The wall panel components can be made entirely out of concrete, concrete facing attached to a light gauge steel frame, or cementitious board attached to a light gauge steel frame. The actual building components are then represented as 3D virtual models in a virtual library. The 3D model software that drives the system should be affordable or free. The preferred 3D modeling software is SketchUp by Google as the software is free and has the fastest utilization growth rate worldwide. SketchUp is extremely intuitive and easy to learn.

### BRIEF DESCRIPTION OF THE DRAWINGS

FIG. 1 illustrates the three basic standardized wall component types of the system: solid wall panel type; opening wall type: and the corner wall type.

FIG. 2 illustrates an example of opening wall panel with a built-in wall opening.

FIG. 3 illustrates a wall assembly with the solid wall panel and opening wall panel type.

FIG. 4 illustrates the preferred floor panel for this building system.

FIG. 5 illustrates an example assembly of how the wall panels and floor panels can be assembled.

FIG. 6 illustrates the top view of the assembly shown in FIG. 5.

FIG. 7 illustrates an all-concrete panel version that has the side cast-in-place concrete stud cavities.

FIG. 8 illustrates the all-concrete panel version with recessed inside surface of the concrete frame to minimize surface contact between interior sheathing and the concrete frame.

FIG. 9 illustrates an optional thermal strip with recessed surface that can be applied to the inside surface of the steel frame to minimize the surface contact between the steel frame and interior sheathing.

### DETAILED DESCRIPTION OF THE INVENTION

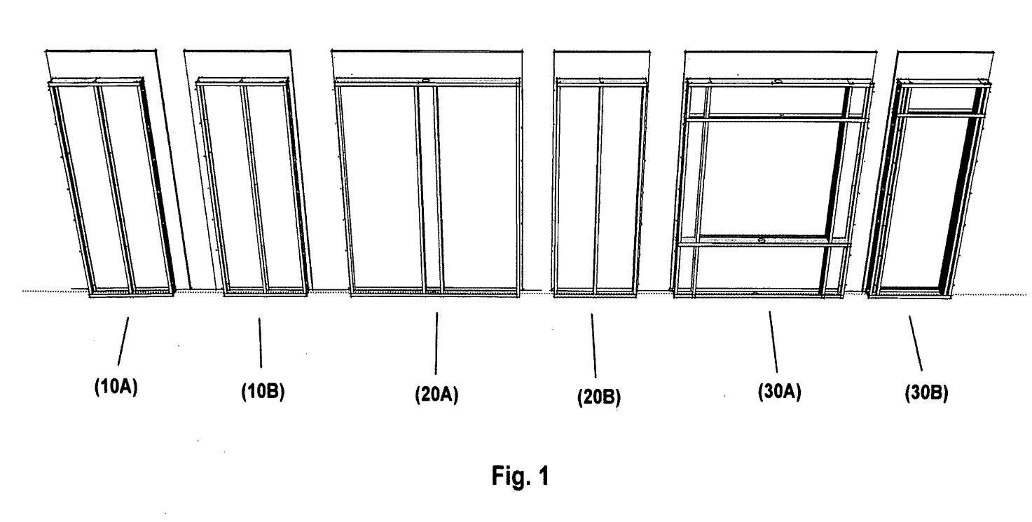

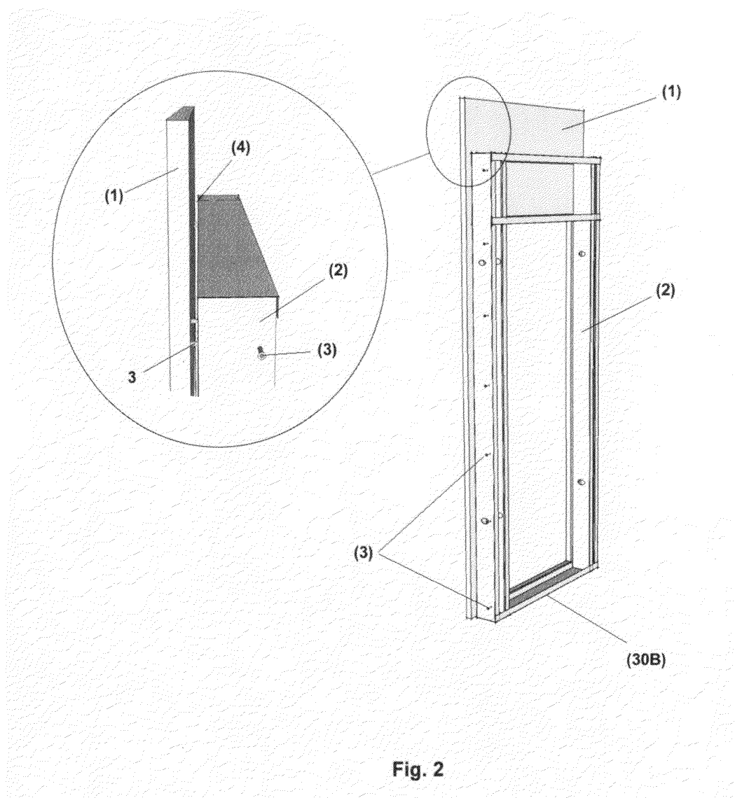

The component building system has three basic standardized wall panel types: solid wall panel type; opening wall type: and the corner wall type. The fourth wall panel minor types have the same basic wall panel design except its width can vary in length and it can be with or without openings—as this type is meant to allow some customization in designing most structures. Obviously, any customizable panel component will cost more than standardized panels in any production environment, so this building system will keep this aspect to the minimum application. Standardized panels not only reduce labor cost through eliminating redundancies, they facilitate and reduce other cost in the building process from designing to engineering, and they reduce the complexity of the process. FIG. 1 illustrates three basic standardized wall panel types. In each standardized wall panel type, the system can have any number of standard width panels that are narrow enough to be easily transported on ordinary trucks. In FIG. 1, example of two standard widths of 4′ and 8′ are shown for both the solid wall panel type (20A and 20B) and the opening wall type (30A and 30B). The narrow width of these panels makes it easier to transport on truck. FIG. 2 illustrates the basic wall design of an opening wall panel type (30B) and of all other wall panel types. The basic wall panel design is comprised of thin cementitious exterior sheathing (1) with a narrower and shorter frame (2) attached to it (1). The frame (2)'s depth, height, and width can vary depending on the desirable load-bearing characteristic of panel. Since the frame (2) depth and width determines width and depth of the cast-in-place concrete columns at the panel sides, we vary these parameters to increase or decrease the load-bearing capacity of the concrete columns. The frame (2) height can vary also to increase or decrease the carry capacity of the horizontal cast-in-place concrete beams. In cases where the panel serves as interior load-bearing wall, the height of the frame (2) can be the same as the exterior sheathing (1). FIG. 2 shows the preferred design that a steel frame (2) attached to a precast concrete slab (1) via anchor-fasteners (3) and allows air gap between the concrete (1) and the steel frame (2). The anchor-fasteners (3) can be detachable so later the steel frame (2) can be removed after the concrete hardened to save steel cost. Having air gap in between the concrete and steel will greatly improve the thermal performance of the panel. The anchor-fasteners (3) attached at the side of the frame (2) are optional to anchor the steel studs onto the side concrete columns. FIG. 2 illustrates the preferred wall panel design made of steel frame (2) and precast concrete sheathing (1); but, the wall panel can be made entirely with concrete. The essential concept of the wall panel is that its design will allow cast-in-place concrete columns and horizontal beam in each panel.

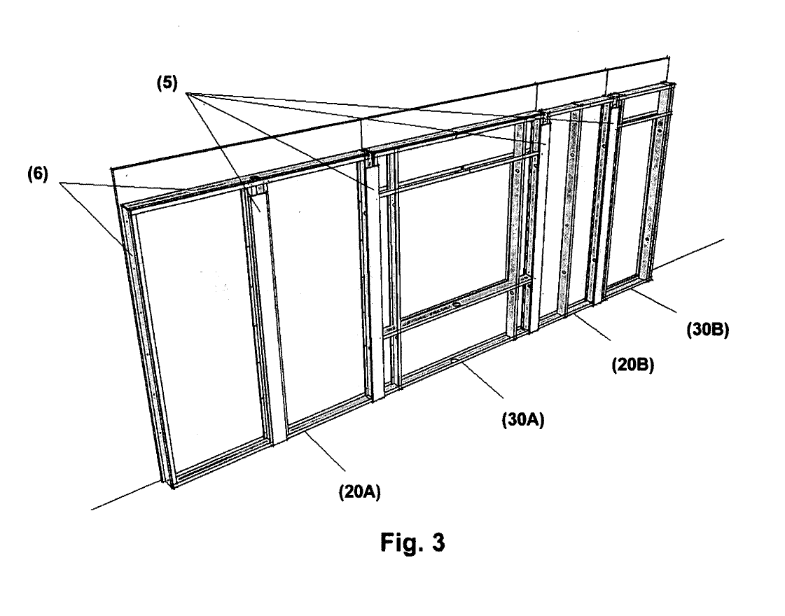

FIG. 3 illustrates an example wall assembly where a standardized door-opening panel (30B) and a window-opening panel (30A) are assembled together with two other solid wall panels (20A and 20B). In this figure, the assembled panels provide concrete stud cavities between panels. Temporary concrete form plates (5) are installed to contain the wet concrete poured from the top of cavities. Foam strip (6) attached at frame sides is optional to reduce thermal conductivity between the concrete and steel frame. Foam strip (6) is not required if the steel frame touches the concrete facing (1) in some applications. The foam strip (6) is also not required when the whole entire wall panel is cast out of concrete having the same design shape.

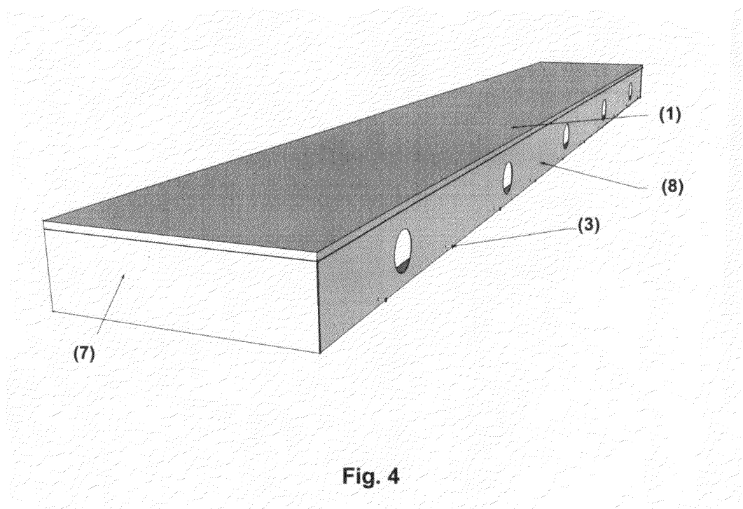

FIG. 4 illustrates the preferred floor panel component. This floor panel is comprised only of two steel joists (8) and end tracks (7) attached to a thin concrete slab (1). The anchor-fastener (3) is necessary if the two side steel joist (8) stay-in-place when the concrete joists are cured, else the entire bottom steel joist system can be removed to save cost of steel.

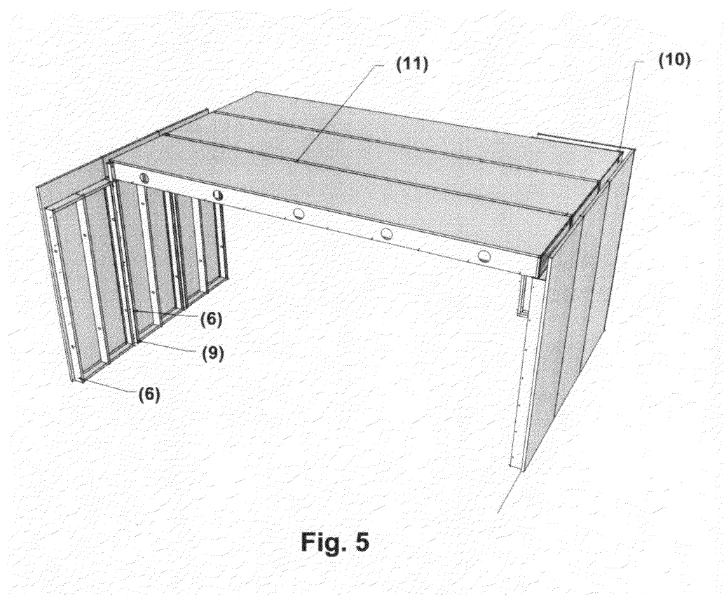

FIG. 5 illustrates an example assembly in which the standardized wall components and floor components are assembled. This is a good example showing the principle concept of building system. Notice when the components are assembled, the assembly forms cavities for cast-in-place concrete studs (9), joists (11), and girders (10). The thermal isolating foam strips (6) are optional shown in this figure. A self-consolidating concrete or other high slump concrete is required to fill in all cavities from above to form a load-bearing concrete frame that also fuses all component elements together into a monolithic structure without need of sealing joints.

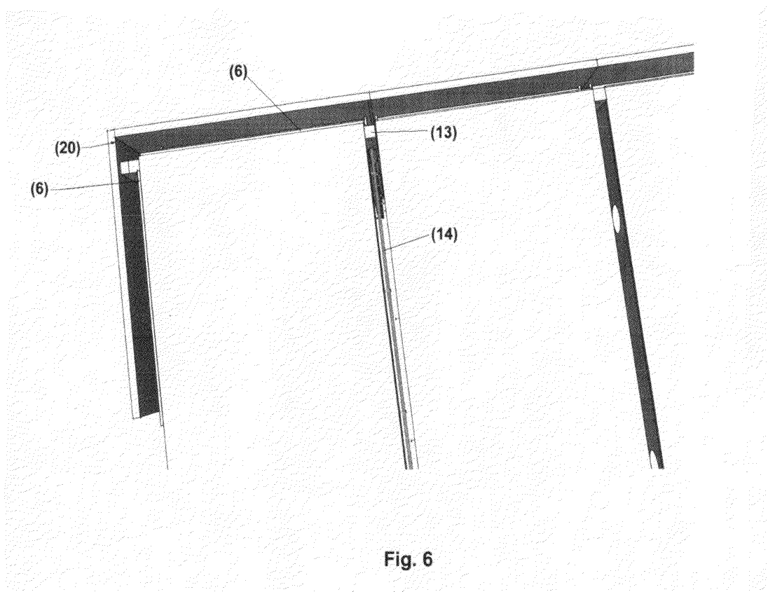

FIG. 6 illustrates the same assembly in FIG. 5 from above. Notice the cavity running horizontally above the wall panel components and side cavities between the floor panels. This figure shows the system's preferred floor panel as shown in FIG. 4, but the system can be adapted to use other floor planks as well. From this top view, one can see how the corner cavity (20) is formed from the corner wall panels. In casting concrete joist rebar (14) is necessary. The thermal isolating block (13) that allows the rebar to go through and tie to concrete girder is optional. The foam strips (6) that isolate the floor panels and concrete girder are also optional to improve thermal performance of the structure.

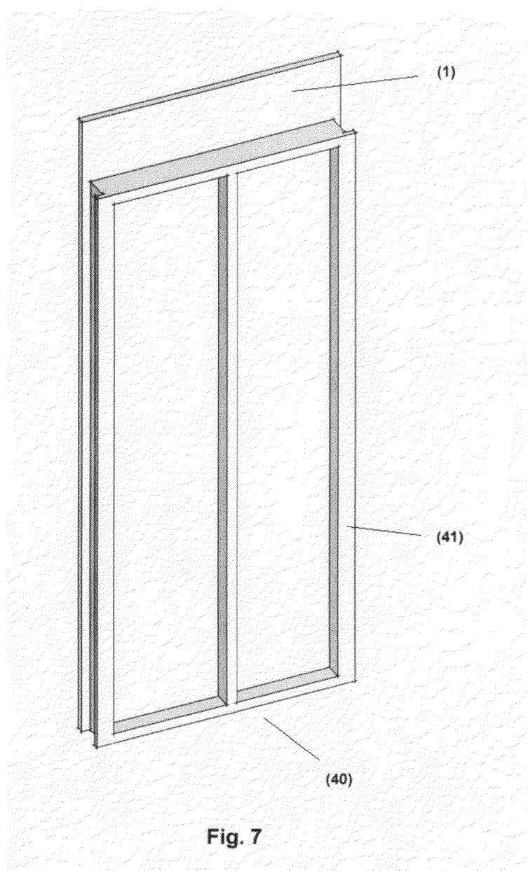

FIG. 7 illustrates how the system's wall panel design with all its functionalities can be made entirely out of cast concrete. The frame (41) is now made of cast concrete. In this panel version (40), the concrete wall panel component will be cheaper in material as concrete frame is cheaper than steel frame. However, it will be slightly heavier than the steel frame panel.

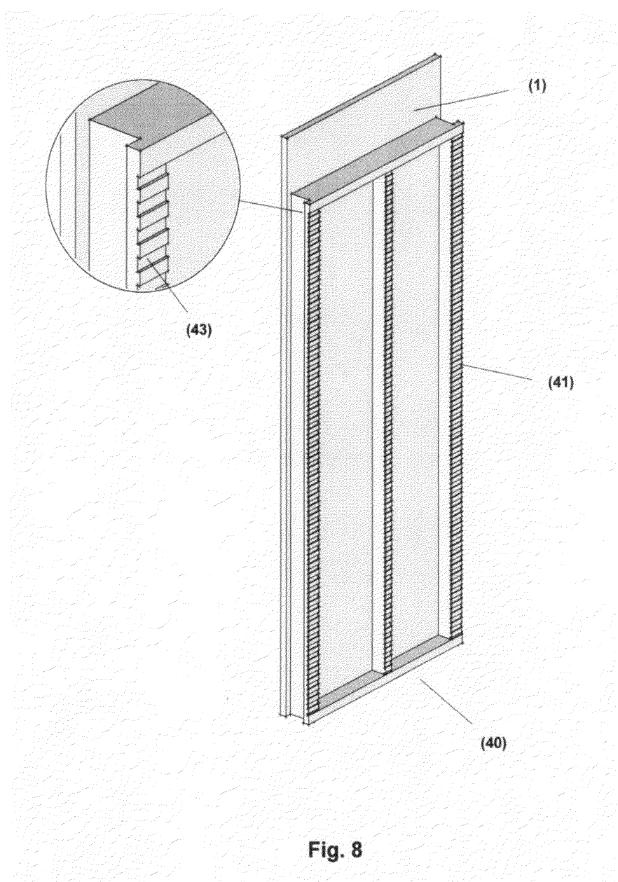

FIG. 8 illustrates how an all-concrete panel version (40) with concrete frame (41) can have recessed surface (43) in the inside surface of the concrete frame (41) to minimize surface contact between interior sheathing or gypsum board and the concrete frame (41). The recessed surface (43) will improve the thermal performance of the wall panel.

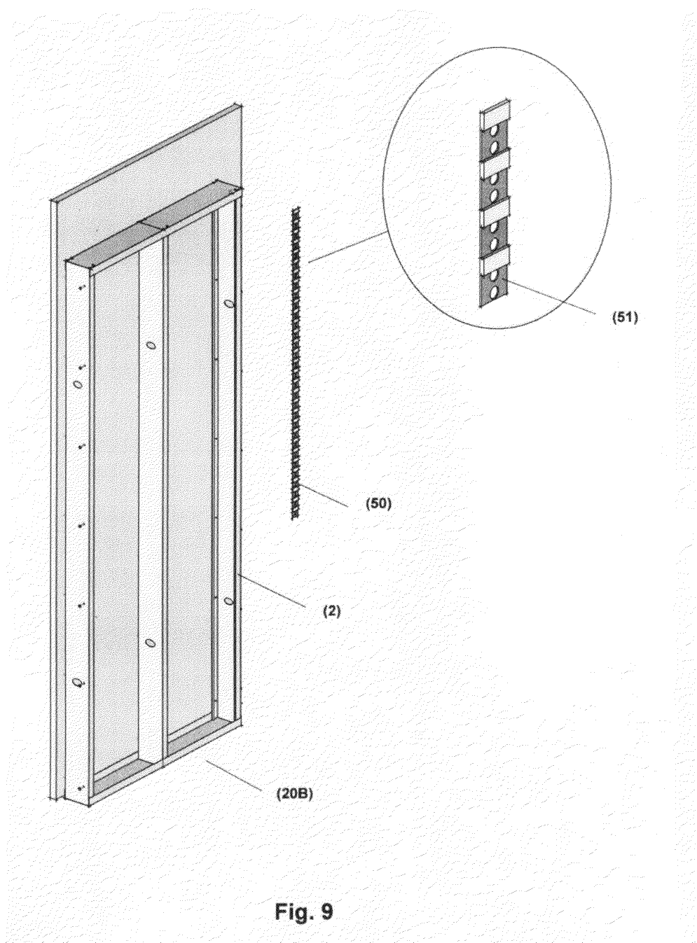

FIG. 9 illustrates how an optional thermal strip (50) with recessed inside surface (51) and with adhesive back can be applied to the steel frame (2) of the wall panel (20B) to reduce the thermal flow between the interior sheathing and the steel frame (2). The thermal strip will increase the thermal performance of the wall panel.

What is claimed is:

1. A component building system comprising:
open rib or frame wall panel component type with a narrower back supporting frame and with no opening for doors or windows;
open rib or frame wall panel component type with narrower back supporting frame and with opening for either at least one door or a window or both;
open rib or frame wall panel component type with narrower back supporting frame and with an exterior face extended further outward on one side designed to be a corner component type;
open rib or frame floor panel component type with supporting frame of equal width and length or any standard floor plank products such as the hollow core floor plank;

2. The component building system according to claim 1, wherein all the system's component types are virtually represented in a three-dimensional modeling software environment that has programmed functions to facilitate rendering, assembling, and calculating cost.

3. The component building system according to claim 1, wherein the back supporting frame of all open rib panel components is made of light gauge steel frame attached to cementitious sheathing or cast concrete and the light gauge steel frame is narrower than the panel's face to create cavity for cast-in-place concrete studs or joist on both side of panel components.

4. The component building system according to claim 1, wherein all open rib panel components are made entirely of concrete with the back concrete supporting frame narrower than the panel's face to create cavity for cast-in-place concrete studs on both sides of panel components.

5. The open rib panel components according to claim 4, wherein the inside surface of concrete frame of the panel is recessed at intervals to limit the contact surface area between the concrete frame material and the interior sheathing.

6. The component building system according to claim 1, wherein all open rib wall panel components with light gauge steel frame can have separate thermal plastic strips with recessed inside surface and perforated holes attached to the inside surface of the frame to limit the contact surface in the interior sheathing.

7. The component building system according to claim 1, wherein the majority of open rib panel components are standardized in various sizes and some can be customizable components of same panel design to allow some flexibility of the system.

8. An open rib or frame wall panel comprising a cementitious sheathing and a narrower supporting frame attached to the cementitious sheathing's back with both panel sides shaped to create cavities for cast-in-place concrete to form concrete supporting studs.

9. The open rib or frame wall panel according to claim 8, wherein the cementitious sheathing is made of concrete, fiber reinforced concrete, magnesium oxide board, cement board, or gypsum board.

10. The open rib or frame wall panel according to claim 8, wherein the back supporting frame can be shorter than cementitious sheathing to create additional cavities for cast-in-place concrete to form a concrete horizontal beam running between concrete studs.

11. The open rib or frame wall panel according to claim 8, wherein the back supporting frame is made of a light gauge steel frame attached to the cementitious sheathing via fasteners which fasteners can be either permanently fixed, or made to be removed after the concrete studs and beam have hardened and the steel frame can be removed to save steel material.

12. The open rib or frame wall panel according to claim 8, wherein the back supporting frame is made of concrete and the cementitious sheathing is made of concrete.

13. The open rib or frame wall panel according to claim 12, wherein the inside surface of the back supporting frame is recessed in intervals to reduce the surface contact area that touch another sheathing when the wall panel is closed.

14. The open rib or frame wall panel according to claim 11, wherein the inside surface of the back steel frame can have a thermal insulative strip with recessed surface and perforations attached to the steel flange to reduce thermal flow between the steel frame and the attached sheathing.

15. A thermal insulative strip for usage between steel frame and attaching sheathings to reduce thermal flow between the steel frame and the attaching sheathing, wherein the thermal insulative strip is made of thermal plastic and has recessed surface and perforated holes.
